(19) United States
(12) Patent Application Publication
(10) Pub. No.: US 2026/0183578 A1
(43) Pub. Date: Jul. 2, 2026

(54) PERSONAL AIR PURIFIER

(71) Applicants: Fausto Arpino, Cassino (IT); Giorgio Buonanno, Cassino (IT)

(72) Inventors: Fausto Arpino, Cassino (IT); Giorgio Buonanno, Cassino (IT)

(21) Appl. No.: 18/865,449

(22) PCT Filed: May 17, 2023
(86) PCT No.: PCT/IB2023/055069

§ 371 Date: Nov. 13, 2024

(30) Foreign Application Priority Data
May 18, 2022 (IT) 102022000010346

(51) Int. Cl. A62B 7/10

(52) U.S. Cl. CPC A62B 7/10

(57) ABSTRACT

A personal ventilation device comprising a power supply system for the operation, a control section to handle the supply of power, a user interface, a containing casing, where a suction opening is obtained, through which an air flow is sucked from the surrounding environment, air moving means housed inside said containing casing and designed to cause the suction of air and the release thereof to the outside, and a filtering system housed inside the containing casing and designed to remove polluting/pathogen agents from the air sucked in. In the containing casing there are obtained a first air outlet opening with the shape of an upside-down “U” and a second air outlet opening with a substantially circular shape and arranged under said first outlet opening.

### CROSS-REFERENCE TO RELATED APPLICATIONS

This patent application claims priority from Italian patent application no. 102022000010346 filed on May 18, 2022, the entire disclosure of which is incorporated herein by reference.

### TECHNICAL FIELD

The present invention relates to a personal air purifier useful for scenarios in which the user occupies a substantially stationary position.

### BACKGROUND

Every year, according to the WHO, more than 8 million people die from pollution, and over 4 million of these deaths are attributable to exposure to anthropogenic pollutants emitted in daily indoor activities.

Indoor environments are particularly hazardous due to the presence of viral or bacterial pathogens, such as influenza.

Recently, this problem has been particularly felt due to the worldwide spread of the SARS-COV-2 virus. The SARS-CoV-2 pandemic forced us to seriously reflect the organization of indoor environments such as work or catering places. In fact, in this type of environment, the occupants often have a very short interpersonal distance for a significant amount of time. If one of the people is infected, the probability of infecting people who share the same environment is therefore very high.

As per EN 16798-1 and -2 regulations, one of the most effective methods for improving indoor air quality with regard to pollutants in living and working environments is ventilation and, therefore, air renewal by introducing outdoor air.

However, in order to ensure adequate ventilation to minimize exposure to pollutants and respiratory pathogens, the air masses involved in the renewal are significant, which necessarily results in high energy consumption and operating costs. These issues limit the adoption of effective air exchange systems as required by the current regulations.

In order to limit energy consumption and costs, local ventilation and air treatment systems, i.e., systems aiming to provide clean air only to people's breathing environment, have been considered for some time now.

The inventors of the present invention created a personal ventilation and air treatment device, which only processes the air necessary to treat the small portion of the environment occupied by the user. In this way, the technical features of the device are such as to ensure low energy consumption and low running costs while ensuring high effectiveness in protecting against pollutants and pathogens.

### SUMMARY

In particular, the device which is the object of the present invention is capable of fluid-dynamically circumscribing a volume within an enclosed space, in which the person to be protected can breathe air treated by the device, ensuring a significant reduction in the concentration of airborne pollutants and respiratory pathogens.

The object of the present invention is a personal ventilation device comprising a power supply system for the operation, a control section to handle the supply of power, a user interface, a containing casing, where a suction opening is obtained, through which an air flow is sucked from the surrounding environment, air moving means housed inside said containing casing and designed to cause the suction of air and the release thereof to the outside, a filtering system housed inside said containing casing and designed to remove polluting/pathogen agents from the air flow sucked in; said device being characterized in that in said containing casing there are obtained (a) a first air outlet opening with the shape of an upside-down “U” and (b) a second air outlet opening with a substantially circular shape and arranged under said first outlet opening; said device being configured so that said first outlet opening is crossed by an air flow with a speed ranging from 1 to 8 m/s and said second outlet opening is crossed by an air flow with a speed ranging from 0.5 to 4 m/s; the air flow flowing through the first outlet opening being 1 to 4 m/s faster than the air flow flowing through the second outlet opening.

Herein, the position indications, such as “top”, “above” and “under”, refer to the operating position of the device as shown in the attached figures.

Preferably, said first outlet opening has a height ranging from 5 to 15 cm and a width ranging from 5 to 13 cm; said first outlet opening is defined by a slit with a cross opening ranging from 1 to 10 mm. Preferably, the slit has a diverging axis.

Preferably, the second outlet opening 12 has a diameter ranging from 1 to 5 cm.

Preferably, said second outlet opening is arranged along a longitudinal symmetry axis of said first outlet opening.

Preferably, said device processes an air flow rate ranging from 20 to 40 m3/h.

Preferably, said device comprises air rotation means designed to produce a swirl air flow flowing out of said second outlet opening.

Preferably, the power supply system comprises one or more batteries.

### BRIEF DESCRIPTION OF THE DRAWINGS

An embodiment of the device which is the object of the present invention is described below for illustrative and non-limiting purposes with reference to the attached figures, wherein:

FIG. 1 is a functional architecture block diagram of the air purification device according to one embodiment of the present invention;

FIG. 2 is a top perspective view of a preferred embodiment of the device which is the object of the present invention;

FIG. 3 is a front view of the device in FIG. 1;

FIG. 4 is a section along the line III-III in FIG. 3; and

FIG. 5 shows the device in FIG. 1 in one of its modes of use.

### DESCRIPTION OF EMBODIMENTS

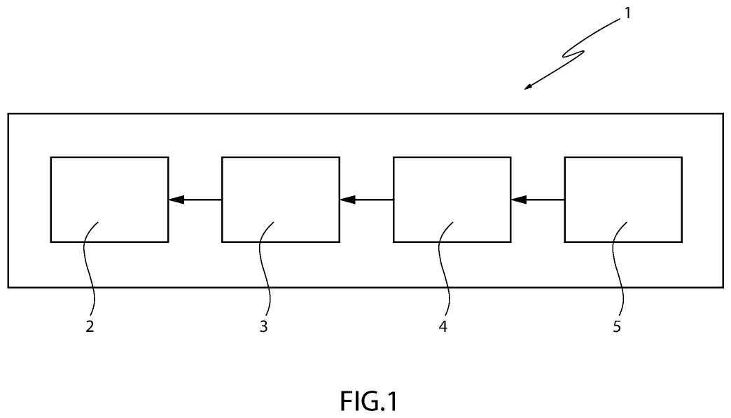

FIG. 1 shows schematically and by means of a block diagram, an example of functional architecture 1 of the air purification device according to a preferred embodiment of the present invention.

The functional architecture 1 comprises air moving means 2, a power supply system 3 designed to enable the air moving means to operate, a control section 4 for controlling the power supply system 3, and a user interface system 5 through which the control section 4 can be operated from the outside.

In particular, the power supply system 3 comprises one or more batteries, so that the device is portable.

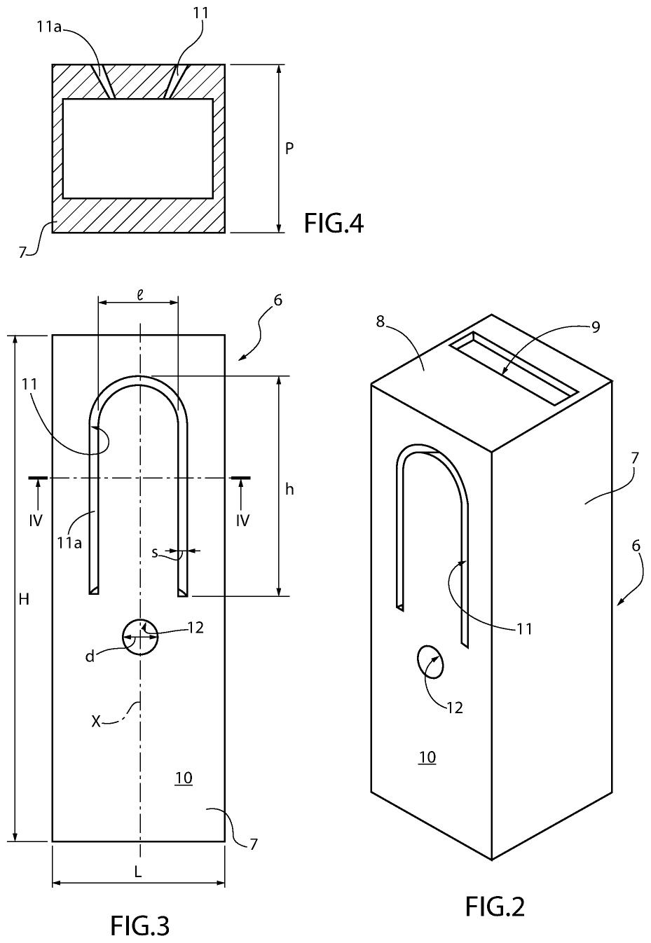

In FIG. 2, the reference numeral 6 indicates, as a whole, a purifying device according to the present invention.

The device 6 comprises a containing casing 7, which houses air handling fans 2 and a filtering system, which is known and not shown for the sake of simplicity, designed to remove pollutants/pathogens from the air flow sucked in.

The containing casing 7 also houses the power supply system 3, the control section 4, and the user interface system 5.

In contrast to the above, the power supply system 3, the control section 4, and the user interface system 5 may be arranged outside the containing casing 7.

The containing casing 7 has a parallelepiped shape, which according to preferred embodiments has maximum overall dimensions of 15 (D)×15 (L)×30 (H) cm and minimum overall dimensions of 7.5 (D)×7.5 (L)×10 (H) cm.

A rectangular suction opening 9 is obtained on a top wall 8, whereas a first outlet opening 11 with the shape of an upside-down “U” and a second outlet opening 12 with a substantially circular shape and arranged under the first outlet opening 11 are obtained on a front wall 10.

The air moving means 2 are designed to suck in air from the surrounding environment through the suction opening 9 and release it at different speeds into the surrounding environment through the first 11 and the second 12 outlet openings.

In particular, air is emitted through the first outlet opening 11 at a higher speed than the air emitted through the second outlet opening 12.

Specifically, the first outlet opening 11 is crossed by an air flow with a speed ranging from 1 to 8 m/s, whereas the second outlet opening is crossed by an air flow with a speed ranging from 0.5 to 4 m/s. The fact that the air flow flowing through the first outlet opening 11 is 1 to 4 m/s faster than the air flow flowing through the second outlet opening 12 is important for the purposes of the present invention. Through the user interface system 5 the user can modulate the air flow speeds through both outlet openings 11 and 12.

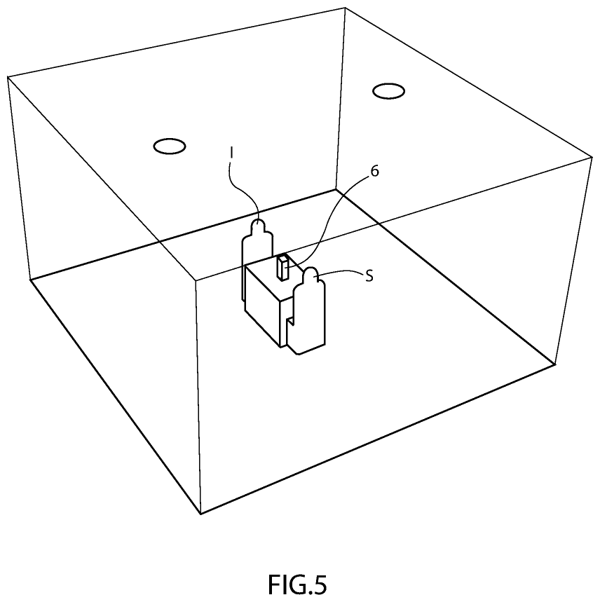

The first outlet opening 11 has a height h ranging from 5 to 15 cm and a width 1 ranging from 5 to 13 cm. The first outlet opening 11 is defined by a slit 11a with a cross opening s ranging from 1 to 10 mm. Preferably, the slit 11a has a diverging axis. The term ‘diverging axis’ means that the inclination of the slit (see FIG. 4) is such as to create a flow of air with outlet sections increasing outwards relative to the front wall 10.

The second outlet opening 12 has a diameter d ranging from 1 to 5 cm and is arranged along a longitudinal symmetry axis X of the first outlet opening 11. Furthermore, the air flow flowing through the second outlet opening 12 takes on a swirl motion caused by appropriate air rotation means.

The device 6 processes an air flow rate ranging from 20 to 40 m³/h.

The operation of the device object of the present invention is based on the sophisticated fluid-dynamic field that it can generate due to the presence of the two outlet openings 11 and 12. In particular, the jet of clean air coming from the first outlet opening 11 creates a fluid-dynamic screen capable of protecting the user using it from pollutants/pathogens, thereby creating a protected microenvironment. At the same time, through the second outlet opening 12, clean air is introduced into the microenvironment formed, thus increasing the level of personal protection.

The effectiveness of the personal protection device was analysed in detail using the most modern three-dimensional computational fluid dynamics (CFD) modelling techniques, which can reproduce with high accuracy the speed and pressure fields of a test case study, in addition to the release and inhalation of pathogens by those present.

FIG. 5 depicts the situation of an example of a computational domain used for testing the performance of the personal protection device. The computational domain reproduces a catering environment equipped with the device of the present invention, within which two people are seated opposite each other at the same table. One of the two people is considered to be infected (I), while the other, considered to be a susceptible person(S), is protected by the personal protection device that is the object of the present invention. The study was carried out on a time-varying basis, by faithfully reproducing the respiratory act (inhalation/exhalation of aerosols/droplets) and assuming that the infected person is speaking loudly in the direction of the susceptible person (the most critical situation). The flow lines obtained demonstrated the ability of the device to create a protective fluid-dynamic barrier between the infected person (I) and the susceptible person(S), thereby protecting the latter. The fluid-dynamic design of the device also ensures reduced air speeds in the immediate vicinity of the susceptible person, thereby ensuring his/her comfort.

1-8. (canceled)

9. A personal ventilation device, comprising:
a power supply system for operation;
a control section to handle the supply of power;
a user interface;
a containing casing, where a suction opening is obtained, through which air flow is sucked from a surrounding environment;
air moving means housed inside said containing casing and designed to cause the suction of air and release thereof to the outside; and
a filtering system housed inside said containing casing and designed to remove polluting/pathogen agents from the air flow sucked in;
said containing casing there are obtained (i) a first air outlet opening with the shape of an upside-down “U” and (ii) a second air outlet opening with a substantially circular shape and arranged under said first outlet opening;
said personal ventilation device being configured so that said first outlet opening is crossed by an air flow with a speed ranging from 1 m/s to 8 m/s and said second outlet opening is crossed by an air flow with a speed ranging from 0.5 m/s to 4 m/s; the air flow flowing through the first outlet opening being 1 m/s to 4 m/s faster than the air flow flowing through the second outlet opening).

10. The personal ventilation device according to claim 9, wherein said first outlet opening has a height ranging from 5 cm to 15 cm and a width ranging from 5 cm to 13 cm; said first outlet opening being defined by a slit with a cross opening ranging from 1 mm to 10 mm.

11. The personal ventilation device according to claim 10, wherein said slit has a diverging axis.

12. The personal ventilation device according to claim 9, wherein said second outlet opening has a diameter ranging from 1 cm to 5 cm.

13. The personal ventilation device according to claim 9, wherein said second outlet opening is arranged along a longitudinal symmetry axis of said first outlet opening.

14. The personal ventilation device according to claim 9, wherein it processes an air flow rate ranging from 20 m³/h to 40 m³ /h.

15. The personal ventilation device according to claim 9, further comprising air rotation means designed to produce a swirl air flow flowing out of said second outlet opening.

16. The personal ventilation device according to claim 9, wherein the power supply system comprises one or more batteries.
